(19) United States
(12) Patent Application Publication
(10) Pub. No.: US 2019/0226434 A1
(43) Pub. Date: Jul. 25, 2019

(54) INTAKE SYSTEM OF INTERNAL COMBUSTION ENGINE

(71) Applicant: TOYOTA JIDOSHA KABUSHIKI KAISHA, Toyota-shi (JP)

(72) Inventors: Tadashi IBARAGI, Nagoya-shi (JP); Takashi MATSUZAWA, Toyota-shi (JP)

(73) Assignee: TOYOTA JIDOSHA KABUSHIKI KAISHA, Toyota-shi (JP)

(21) Appl. No.: 16/236,666

(22) Filed: Dec. 31, 2018

(30) Foreign Application Priority Data
Jan. 19, 2018 (JP) 2018-007407

(51) Int. Cl. F02M 35/12; F02D 9/10

(52) U.S. Cl. CPC F02M 35/1211; F02D 9/104; F02D 9/107

(57) ABSTRACT

An intake system of an internal combustion engine includes an intake pipe through which an intake passage extends, a throttle valve, and a baffle arranged at a downstream side of the throttle valve in the intake passage. The throttle valve includes a shaft, a first valve body configured to close a first region located at a first side, and a second valve body configured to close a second region located at a second side. When the throttle valve opens, the first valve body is pivoted toward an upstream side and the second valve body is pivoted toward a downstream side. The baffle includes a ring, a first net located at the first side of the ring, and a second net located at the second side of the ring. The first net occupies a larger region than the second net.

### BACKGROUND ART

The present disclosure relates to an intake system of an internal combustion engine.

Japanese Laid-Open Patent Publication No. 2007-247547 describes an intake system of an internal combustion engine including an intake pipe, through which an intake passage extends, and a butterfly type throttle valve, which is arranged in the intake passage. The throttle valve includes a shaft supported to be pivotal relative to the intake pipe. The shaft extends in a direction orthogonal to the axial direction (longitudinal direction) of the intake pipe. In a view taken from the axial direction of the intake passage, a first valve body is fixed to the shaft. The first valve body is shaped as a semicircular disc and closes a region of the intake passage located at one side of the shaft. Further, in the view taken from the axial direction of the intake passage, a second valve body is fixed to the shaft. The second valve body is shaped as a semicircular disc and closes a region of the intake passage located at the other side of the shaft. The shaft is pivoted relative to the intake pipe so that the first and second valve bodies open and close the intake passage, which is circular in a cross-sectional view.

A baffle is arranged in the intake passage at a downstream side of the throttle valve. The baffle includes a ring. The ring is fixed to the inner surface of intake pipe. Further, the baffle includes a net fixed to the ring. More specifically, the net is arranged radially inward from the ring. In the view taken from the axial direction of the intake pipe, the net is semicircular and occupies a region that is substantially one-half of the intake passage.

In the intake system, intake air flows through the intake passage when the throttle valve is open. When intake air flows through the intake passage in such a manner, the velocity of the intake air is increased at the downstream side of the throttle valve. An increase in the velocity of the intake air may swirl the intake air and generate noise. In the intake system, some of the intake air flowing through the entire intake passage passes through the net. The net reduces swirling of the passing intake air and decreases noise. However, noise may be generated by the intake air that does not pass through the net.

The net may be arranged, for example, to entirely occupy the open space located radially inward from the ring so that substantially all of the intake air would pass through the net and thereby decrease the generation of noise. However, this will increase the resistance of the intake air passing through the net. Accordingly, it is required that the noise generated by the baffle be decreased without overly increasing the resistance of the intake air passing through the baffle.

### SUMMARY

One aspect of the present disclosure is an intake system of an internal combustion engine. The intake system includes an intake pipe through which an intake passage extends, a throttle valve arranged in the intake passage, and a baffle arranged at a downstream side of the throttle valve in the intake passage. The throttle valve includes a shaft pivotally supported by the intake pipe and extending in a direction orthogonal to an axial direction of the intake pipe, a first valve body configured to close a first region of the intake passage located at a first side of the shaft in a view taken from the axial direction of the intake pipe, and a second valve body configured to close a second region of the intake passage located at a second side of the shaft opposite to the first side in the view taken from the axial direction of the intake pipe. The throttle valve is configured so that when the throttle valve opens, the first valve body is pivoted toward an upstream side and the second valve body is pivoted toward a downstream side. The baffle includes a ring fixed to the intake pipe, a first net arranged radially inward from the ring and fixed to a portion of the ring located at the first side, and a second net arranged radially inward from the ring and fixed to a portion of the ring located at the second side. The first net occupies a larger region than the second net in the view taken from the axial direction of the intake pipe.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram of an internal combustion engine;

FIG. 2 is a cross-sectional view showing a throttle valve mechanism; and

FIG. 3 is a front view of a baffle.

### DETAILED DESCRIPTION OF THE INVENTION

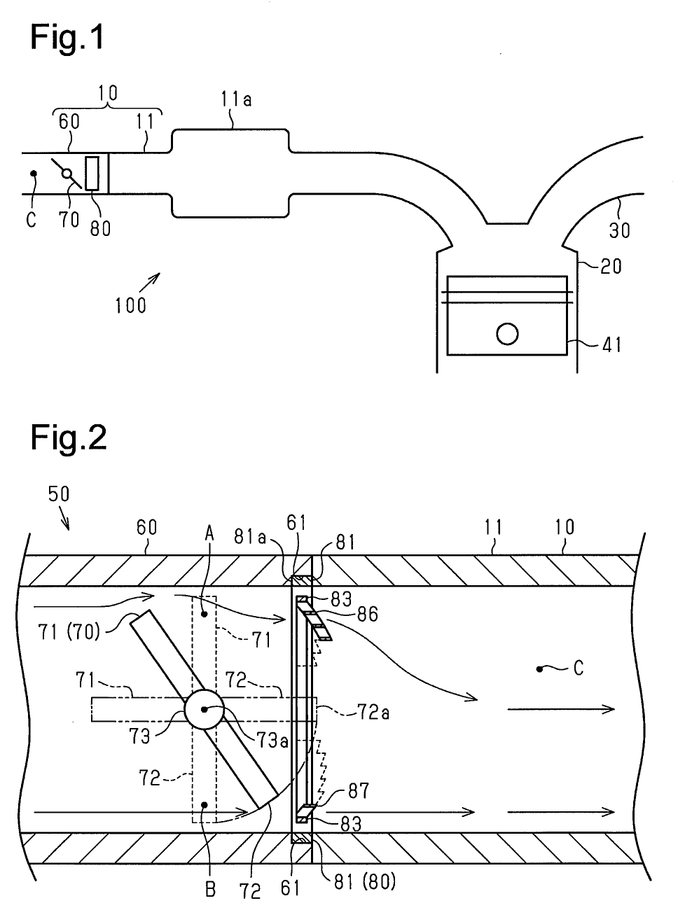

One embodiment of the present disclosure will now be described with reference to FIGS. 1 to 3. In the description hereafter, the terms upstream and downstream will be used with respect to the direction in which intake air and exhaust gas flow.

As shown in FIG. 1, an internal combustion engine 100 includes an intake pipe 10 that draws in intake air from outside the internal combustion engine 100. An intake passage C is defined in the intake pipe 10 by the space inside the intake pipe 10. That is, the intake passage C extends through the intake pipe 10. As shown in FIG. 2, the throttle valve mechanism 50 includes a cylindrical housing 60. The housing 60 forms part of the intake pipe 10. A butterfly type throttle valve 70 is arranged inside the housing 60 to control the amount of intake air flowing through the intake passage C. An upstream intake pipe (not shown) is connected to the upstream end of the housing 60.

As shown in FIG. 2, the downstream end of the housing 60 is connected to the upstream end of a downstream intake pipe 11. As shown in FIG. 1, a surge tank 11a is arranged in the downstream intake pipe 11 to reduce pulsation of the intake air.

As shown in FIG. 1, the downstream end of the downstream intake pipe 11 is connected to a cylinder 20 that mixes the intake air with fuel and burns the mixture. A piston 41 is reciprocated inside the cylinder 20. The cylinder 20 is connected to an exhaust pipe 30 to discharge exhaust gas out of the cylinder 20.

The structure of the throttle valve mechanism 50 will now be described in detail.

As shown in FIG. 2, the housing 60 of the throttle valve mechanism 50 is substantially cylindrical. The space inside the housing 60 defines part of the intake passage C in the intake pipe 10. The intake passage C in the housing 60 includes a portion where the throttle valve 70 is arranged defining a flow passage having a substantially circular cross section. The throttle valve 70 includes a substantially rod-shaped shaft 73. The shaft 73 extends in the intake pipe 10 in a direction orthogonal to an axial direction of the housing 60 (sideward direction in FIG. 2, or longitudinal direction of intake pipe 10). That is, the shaft 73 extends in a direction orthogonal to the plane of FIG. 2. The shaft 73 is pivotally supported by the housing 60. One end of the shaft 73 is coupled to an output shaft of a motor (not shown). The output shaft of the motor rotates to pivot the shaft 73 about its center axis 73a.

A first valve body 71 shaped as a substantially semicircular disc extends from the shaft 73 outward in the radial direction of the shaft 73. Further, a second valve body 72 shaped as a substantially semicircular disc extends from the shaft 73 outward in the radial direction of the shaft 73. The second valve body 72 extends from the shaft 73 in a direction opposite to the direction in which the first valve body 71 extends. That is, the shaft 73 is located between the first valve body 71 and the second valve body 72. In a front view of the throttle valve 70, the first valve body 71 and the second valve body 72 have a circular form as a whole.

In FIG. 2, the throttle valve 70 is shown in a fully open state by double-dashed lines. When the shaft 73 is pivoted from the fully open state in the clockwise direction as viewed in FIG. 2, that is, when the shaft 73 is pivoted toward one side in the circumferential direction, the open amount of the throttle valve 70 decreases. As shown by the broken lines in FIG. 2, when the planar direction of the first valve body 71 and the second valve body 72 is orthogonal to the axial direction of the housing 60 (sideward direction in FIG. 2), the throttle valve 70 is in a fully closed state. When the throttle valve 70 is in the fully closed, the first valve body 71 closes a first region A of the intake passage C. Further, the second valve body 72 closes a second region B of the intake passage C. In a view taken from the axial direction of the housing 60, the first region A is a region located at one side of the shaft 73 (upper region in FIG. 2). Further, the second region B is a region located at the other side of the shaft 73 (lower region in FIG. 2).

When the shaft 73 is pivoted from the fully closed state in the counterclockwise direction as viewed in FIG. 2, that is, when the shaft 73 is pivoted toward the other side in the circumferential direction, the open amount of the throttle valve 70 increases. As shown by the double-dashed lines in FIG. 2, when the planar direction of the first valve body 71 and the second valve body 72 lie in the axial direction of the housing 60, the throttle valve 70 is fully open. More specifically, the first valve body 71 is pivoted toward the upstream side (left side in FIG. 2) to fully open the first region A. Further, the second valve body 72 is pivoted toward the downstream side (right side in FIG. 2) to fully open the second region B. The second valve body 72 includes a downstream-most portion 72a located most downstream when the throttle valve 70 is in the fully open state. Further, the downstream-most portion 72a is located downstream from the downstream end surface of the housing 60 when the throttle valve 70 is fully open.

An inner wall surface of the housing 60 includes an attachment recess 61 that is recessed radially outward in the housing 60. The attachment recess 61 is located at the downstream end of the housing 60. The attachment recess 61 extends throughout the housing 60 in the circumferential direction and is ring-shaped in a view taken in the axial direction of the housing 60 (sideward direction in FIG. 2).

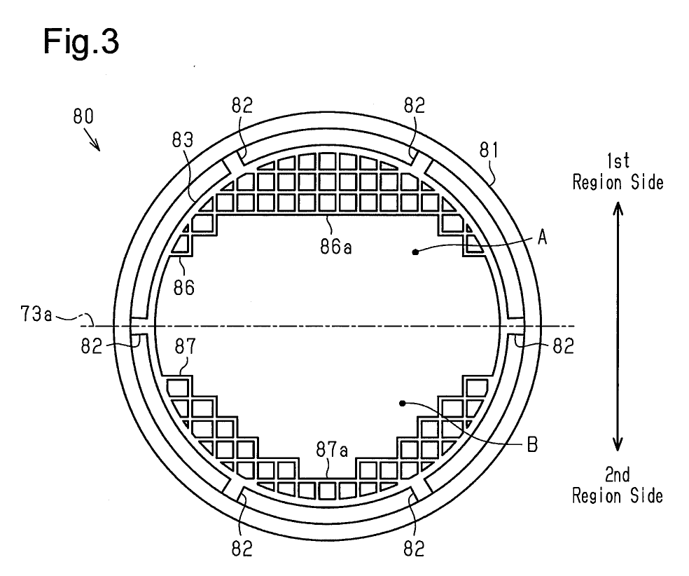

As shown in FIG. 2, a baffle 80 is arranged in the intake passage C at the downstream side of the throttle valve 70. As shown in FIG. 3, the baffle 80 includes a substantially round gasket 81 formed from a rubber material. As shown in FIG. 2, the gasket 81 has an outer diameter that is substantially the same as an inner diameter of the attachment recess 61. Further, in the axial direction of the housing 60, the gasket 81 has a thickness that is substantially the same as a width of the attachment recess 61. The gasket 81 is held between an inner wall of the attachment recess 61 and the upstream end of the downstream intake pipe 11. That is, the gasket 81 is fixed to the intake pipe 10. The gasket 81 has a center axis that substantially coincides with the center axis of the housing 60. In the present embodiment, the gasket 81 corresponds to a ring.

As shown in FIG. 3, a generally round support 83 is located at a radially inner side of the gasket 81. The support 83 is connected by a plurality of links 82 to the gasket 81. The links 82 extend radially inward from the inner edge of the gasket 81. The links 82 are arranged at equal intervals in the circumferential direction of the gasket 81 at six locations. The radially inner end of each link 82 is connected to the radially outer edge of the support 83. The support 83 has a center axis that substantially coincides with a center axis of the gasket 81.

As shown in FIG. 3, a first net 86 and a second net 87 are fixed to the radially inner edge of the support 83. In the present embodiment, the first net 86 and the second net 87 are fixed by the support 83 and the links 82 to the gasket 81.

As shown in FIG. 3, the first net 86 is arranged at an upper side of a radially inner region of the support 83. The upper side corresponds to the first region A. The first net 86 extends in the circumferential direction of the support 83 along the radially inner edge of the support 83. The first net 86 extends from the radially inner edge of the support 83. The edge of the support 83 along which the first net 86 extends corresponds to substantially two-thirds of the edge of the support 83 in the first region A and is separated from the center axis 73a of the shaft 73. The first net 86 is arranged on the upper edge of the support 83 so as to be separated from the center axis 73a of the shaft 73. That is, in the present embodiment, the first net 86 is not arranged in in the vicinity of the center axis 73a of the shaft 73 in a view taken from the axial direction of the housing 60.

In the view taken from the axial direction of the housing 60, the first net 86 does not exist at the side of the first region A corresponding to the second region B. That is, the first net 86 has a substantially crescent shape. More specifically, the first net 86 has a width in the radial direction of the support 83 that is large at the middle in the direction in which the first net 86 extends and small at the two ends in the direction in which the first net 86 extends. The direction in which the first net 86 extends is the direction in which the first net 86 extends along the edge of the support 83. Further, the first net 86 includes a radially inner edge defining a first edge 86a opposed toward the second region B. The first edge 86a is slightly recessed toward the upper side as viewed in FIG. 3, that is, from the second region B toward the first region A.

As shown in FIG. 2, the first net 86 is curved along the pivoting path of the second valve body 72 so as not to interfere with the second valve body 72 when the throttle valve 70 is pivoted. The pivoting path of the second valve body 72 refers to the region that the distal end of the second valve body 72 passes through when the throttle valve 70 is pivoted. More specifically, the first net 86 is arranged so as to extend toward the downstream side of the intake passage C in the radially inward direction of the gasket 81. In FIG. 2, the broken lines show portions of the first net 86 located in a direction extending toward the other side of the plane of the drawing.

As shown in FIG. 3, the second net 87 is arranged at a lower side of a radially inner region of the support 83 in a view taken from the axial direction of the housing 60. The lower side corresponds to the second region B. The second net 87 extends from the radially inner edge of the support 83. The edge of the support 83 along which the second net 87 extends corresponds to substantially three-fourths of the edge of the support 83 in the second region B and is separated from the center axis 73a of the shaft 73. The second net 87 is arranged on the lower edge of the support 83 so as to be separated from the center axis 73a of the shaft 73. That is, in the present embodiment, the second net 87 is not arranged in the vicinity of the center axis 73a of the shaft 73 in the view taken from the axial direction of the housing 60.

In the view taken from the axial direction of the housing 60, the second net 87 does not exist at the side of the second region B corresponding to the first region A. That is, the second net 87 has a substantially crescent shape. More specifically, the second net 87 has a width in the radial direction of the support 83 that is substantially the same throughout the direction in which the second net 87 extends. The direction in which the second net 87 extends is the direction in which the second net 87 extends along the edge of the support 83. Further, the second net 87 includes a radially inner edge defining a second edge 87a directed toward the first region A. The second edge 87a is recessed toward the lower side as viewed in FIG. 3, that is, from the first region A toward the second region B. Further, in relation with the widths of the first and second nets 86 and 87 in the radial direction of the support 83, the width of the second net 87 is smaller than the middle width (maximum width) of the first net 86.

As described above, the width of the first net 86 is increased at the middle in the direction in which the first net 86 extends, whereas the width of the second net 87 is generally the same in the direction in which the second net 87 extends. Since the width of the first net 86 is increased at the middle, the first net 86 occupies a larger region than the second net 87 in the intake passage C.

As shown in FIG. 2, the second net 87 is curved along the pivoting path of the second valve body 72 and shaped so as not to interfere with the second valve body 72 when the throttle valve 70 is pivoted. More specifically, the second net 87 is arranged so as to extend toward the downstream side of the intake passage C in the radially inward direction of the gasket 81. In FIG. 2, the broken lines show portions of the second net 87 located in the direction extending toward the other side of the plane of the drawing.

As shown in FIG. 2, the second valve body 72 includes the downstream-most portion 72a located at the most downstream side when the throttle valve 70 is fully open. Part of the baffle 80 is located at the upstream side of the downstream-most portion 72a when the throttle valve 70 is fully open. More specifically, the gasket 81 includes an upstream end 81a located upstream from the downstream-most portion 72a when the throttle valve 70 is fully open. The first net 86 and the second net 87 are located toward the downstream side from the pivoting path of the second valve body 72 of the throttle valve 70.

The present embodiment has the advantages described below.

As shown by the arrows in FIG. 2, intake air flows through the intake passage C when the throttle valve 70 is open. When the throttle valve 70 is not fully open, the first valve body 71 and the second valve body 72 of the throttle valve 70 impede the flow of intake air. Accordingly, the static pressure at the downstream side of the throttle valve 70 is lower than the static pressure at the upstream side of the throttle valve 70. This increases the velocity of the intake air at the downstream side of the throttle valve 70. An increase in the velocity of the intake air may swirl the intake air and generate noise. That is, the intake air flowing through the first region A and the second region B may generate noise in or near the first region A and the second region B.

In the present embodiment, the intake air passing through the first region A flows through the first net 86. This reduces swirling of the intake air and limits the generation of noise. Further, the intake air passing through the second region B flows through the second net 87. This reduces swirling of the intake air and limits the generation of noise.

As shown by the solid lines in FIG. 2, when the throttle valve 70 is open but not fully open, the first valve body 71 and the second valve body 72 guide the intake air at the upstream side of the throttle valve 70 toward the distal end of the second valve body 72. Thus, a relatively large amount of intake air flows through the second region B in the intake passage C. The first region A of the intake passage C is opened and closed by the first valve body 71. A smaller amount of intake air flows through the first region A than the second region B. Thus, the static pressure at the downstream side of the first valve body 71 has a tendency to become lower than the static pressure at the downstream side of the second valve body 72. That is, the pressure difference between a location at the upstream side of the first valve body 71 and a location at the downstream side of the first valve body 71 has a tendency to become larger than the pressure difference between a location at the upstream side of the second valve body 72 and a location at the downstream side of the second valve body 72. As a result, the velocity of the intake air is higher and noise is generated more easily at the first region A than the second region B.

In the present embodiment, in a view taken from the axial direction of the housing 60, the first net 86 is located at a position corresponding to the first region A. The first net 86 occupies a larger region of the intake passage C than the second net 87. Thus, the present embodiment limits the generation of noise in a preferred manner as compared with when the first net 86 and the second net 87 occupy regions of the intake passage C having the same area. In a view of the intake pipe 10 taken from the axial direction of the housing 60, the second net 87 is arranged at a location corresponding to the second region B. The second net 87 occupies a smaller region of the intake passage C than the first net 86. Thus, the present embodiment decreases the resistance of the intake air when passing through the baffle 80 as compared with when the second net 87 and the first net 86 occupy regions of the intake passage C having the same area. As a result, the present embodiment decreases the noise generated by the baffle 80 without overly increasing the resistance of the intake air passing through the baffle 80.

In the present embodiment, the second valve body 72 includes the downstream-most portion 72a that is located at the most downstream side when the throttle valve 70 is fully open. When the throttle valve 70 is fully open, the upstream end 81a of the gasket 81 is located toward the upstream side from the downstream-most portion 72a. Thus, the baffle 80 is located in the immediate vicinity of the downstream side of the throttle valve 70. The distance between the first valve body 71 and the first net 86 is relatively short. This reduces swirling of the intake air, which would be caused when the velocity of the intake air passing through the second region B increases, especially at locations where the intake air has a tendency to swirl. Further, the distance between the second valve body 72 and the second net 87 is relatively short. This reduces swirling of the intake air, which would be caused when the velocity of the intake air passing through the second region B increases, especially at locations where the intake air has a tendency to swirl. Further, the distance between the second valve body 72 and the second net 87 is relatively short. As a result, the present embodiment decreases the noise generated in the first region A and the second region B in a preferred manner.

In the present embodiment, the first net 86 is arranged so as to extend toward the downstream side of the intake passage C in the radially inward direction of the gasket 81. The second net 87 is arranged so as to extend toward the downstream side of the intake passage C in the radially inward direction of the gasket 81. That is, in the present embodiment, the first net 86 and the second net 87 extend along the pivoting path of the distal end of the second valve body 72 when the throttle valve 70 pivots from the fully closed state to the fully open state. Thus, the present embodiment avoids interference of the first net 86 and the second net 87 with the second valve body 72 of the throttle valve 70 while reducing swirling of the intake air by arranging the first net 86 and the second net 87 in the radially inward direction of the gasket 81.

In the present embodiment, in a view taken from the axial direction of the housing 60, the width of the second net 87 in the radial direction of the support 83 is smaller than the maximum width of the first net 86. The width of the first net 86 in the radial direction of the support 83 is the maximum at the middle of the first net 86 in the direction in which the first net 86 extends. The direction in which the first net 86 extends is the direction in which the first net 86 extends along the edge of the support 83. In this manner, the present embodiment arranges the second net 87 in a region extending in the circumferential direction of the gasket 81 and includes a region free from the second net 87 at a central portion in the radial direction of the gasket 81. When the throttle valve 70 is fully open, the downstream-most portion 72a of the second valve body 72 is located in the region free from the second net 87. Accordingly, the present embodiment avoids interference of the second valve body 72 with the baffle 80 while arranging the baffle 80 near the throttle valve 70. In this manner, interference of the throttle valve 70 with the first net 86 and the second net 87 is limited. Thus, the first net 86 and the second net 87 do not hinder opening and closing of the throttle valve 70.

The throttle valve 70 of the present embodiment is a butterfly valve. Accordingly, when the throttle valve 70 starts to open from a closed state, in a view taken from the axial direction of the housing 60, a location that is close to the inner wall surface of the housing 60 is opened earlier than a location that is far from the inner wall of the housing 60. Accordingly, in the present embodiment, the intake air in the vicinity of the inner wall surface of the housing 60 has a tendency to flow at a high velocity. In this regard, the present embodiment arranges the first net 86 so as to extend along the circumferential direction of the support 83. That is, the first net 86 is arranged to extend in the circumferential direction along the inner wall surface of the housing 60. This reduces swirling of the intake air at a region where the intake air flows when the throttle valve 70 starts to open. Further, the first net 86 is not arranged at a portion in the radially inner side of the support 83. Thus, for example, in a situation in which the throttle valve 70 is fully open and a large amount of intake air flows through the central portion of the support 83, the first net 86 does not apply excessive resistance to the intake air. The same applies to the second net 87.

As shown by the arrows in FIG. 2, the intake air flowing through the first region A at the downstream side of the throttle valve 70 flows more easily toward the center of the intake passage C than the intake air flowing through the second region B. In the present embodiment, as shown in FIG. 3, in a view taken from the axial direction of the housing 60, the width of the first net 86 at the middle in the direction in which the first net 86 extends (maximum width) is greater than the width of the second net 87. In other words, the first net 86 extends further toward the inner side in the radial direction of the support 83 than the second net 87. Thus, in the present embodiment, swirling of the intake air is more limited in the first region A than when the width of the first net 86 at the middle in the direction in which the first net 86 extends (maximum width) is the same as the width of the second net 87.

It should be apparent to those skilled in the art that the present invention may be embodied in many other specific forms without departing from the spirit or scope of the invention. Particularly, it should be understood that the present invention may be embodied in the following forms.

The location of the baffle 80 in the intake passage C may be changed at the downstream side of the throttle valve 70. For example, as long as noise can be reduced, the upstream end 81a of the gasket 81 can be located downstream from the downstream-most portion 72a when the throttle valve 70 is fully open. Alternatively, the upstream end 81a of the gasket 81 may be located at the same position as the downstream-most portion 72a in the direction in which the intake air flows when the throttle valve 70 is fully open. The gasket 81 may be fixed to, for example, the upstream end of the downstream intake pipe 11 or to an intermediate part of the downstream intake pipe 11. Further, when shortening the distance between the throttle valve 70 and the baffle 80, the baffle 80 may be fixed to, for example, an intermediate part of the housing 60.

In the above embodiment, the gasket 81 of the baffle 80 corresponds to the ring. However, the ring of the baffle 80 does not have to function as a gasket. For example, the ring of a baffle does not have to function as a gasket when an outer circumferential surface of the ring is adhered to the inner wall surface of the intake pipe 10 to fix the ring of the baffle to the intake pipe 10.

The shape of the baffle 80 may be changed. For example, the shape and number of the links 82 can be changed. Further, the links 82 may be omitted, and the support 83 may be fixed to the gasket 81. Alternatively, the links 82 and the support 83 may be omitted, and the first net 86 and the second net 87 may be directly fixed to the gasket 81.

The material of the gasket 81 in the baffle 80 may be changed. For example, the gasket 81 may be formed from metal.

The shapes of the first net 86 and the second net 87 may be changed. For example, if the upstream end 81a of the gasket 81 is located downstream from the downstream-most portion 72a of the second valve body 72 when the throttle valve 70 is fully open, the first net 86 and the second net 87 only need to extend in the radial direction of the gasket 81 and do not have to extend toward the downstream side.

For example, even when the upstream end 81a of the gasket 81 is located toward the upstream side from the downstream-most portion 72a of the second valve body 72 when the throttle valve 70 is fully open, the first net 86 only need to extend in the radial direction of the gasket 81 and does not have to extend toward the downstream side as long as the first net 86 does not interfere with the throttle valve 70.

Further, for example, if the upstream end 81a of the gasket 81 is located downstream from the downstream-most portion 72a when the throttle valve 70 is fully open, the first edge 86a of the first net 86 and the second edge 87a of the second net 87 may extend straight or extend to project inward in the radial direction of the gasket 81. In this manner, when changing the shapes of the first net 86 and the second net 87, the first net 86 only need occupy a larger region of the intake passage C than the second net 87 in a view taken from the axial direction of the housing 60.

The size and shape of the mesh in the first net 86 and the second net 87 of the baffle 80 may be changed in accordance with the velocity, pressure, or the like of the intake air flowing through the baffle 80. Further, the first net 86 may differ from the second net 87 in size and shape of the mesh. For example, one of the first net 86 and the second net 87 may have a larger mesh size than the other one of the first net 86 and the second net 87.

The shape of the housing 60 in the throttle valve mechanism 50 may be changed. For example, the housing 60 may have the form of a substantially elliptic cylinder. In this case, the first valve body 71 and the second valve body 72 may each have the form of a substantially semi-elliptic plate, and the gasket 81 of the baffle 80 may be elliptic accordingly.

The present examples and embodiments are to be considered as illustrative and not restrictive, and the invention is not to be limited to the details given herein, but may be modified within the scope and equivalence of the appended claims.

1. An intake system of an internal combustion engine, the intake system comprising:
an intake pipe through which an intake passage extends;
a throttle valve arranged in the intake passage; and
a baffle arranged at a downstream side of the throttle valve in the intake passage, wherein:
the throttle valve includes
a shaft pivotally supported by the intake pipe and extending in a direction orthogonal to an axial direction of the intake pipe,
a first valve body configured to close a first region of the intake passage located at a first side of the shaft in a view taken from the axial direction of the intake pipe, and
a second valve body configured to close a second region of the intake passage located at a second side of the shaft opposite to the first side in the view taken from the axial direction of the intake pipe;
the throttle valve is configured so that when the throttle valve opens, the first valve body is pivoted toward an upstream side and the second valve body is pivoted toward a downstream side;
the baffle includes
a ring fixed to the intake pipe,
a first net arranged radially inward from the ring and fixed to a portion of the ring located at the first side, and
a second net arranged radially inward from the ring and fixed to a portion of the ring located at the second side; and
the first net occupies a larger region than the second net in the view taken from the axial direction of the intake pipe.

2. The intake system according to claim 1, wherein
the ring includes an upstream end,
the second valve body includes a downstream-most portion located most downward when the throttle valve is fully open,
the upstream end of the ring is located upstream from the downstream-most portion of the second valve body when the throttle valve is fully open,
the first net and the second net are configured so as not to interfere with the second valve body when the throttle valve is pivoted.

3. The intake system according to claim 2, wherein the second net is arranged so as to extend toward the downstream side of the intake passage in a radially inward direction of the ring.

4. The intake system according to claim 2, wherein
the intake passage includes a portion where the throttle valve is arranged defining a flow passage having a circular cross section in the view taken from the axial direction of the intake pipe,
the first valve body and the second valve body are each shaped as a semicircular disc,
the ring is round, and
the second net includes a radially inner edge recessed from the first side toward the second side in the view taken from the axial direction of the intake pipe.
